(19) United States
(12) Patent Application Publication
(10) Pub. No.: US 2016/0243620 A1
(43) Pub. Date: Aug. 25, 2016

(54) ADDITIVE MANUFACTURING SHROUD SUPPORT STRUCTURE

(71) Applicant: UNITED TECHNOLOGIES CORPORATION, Hartford, CT (US)

(72) Inventor: Evan Butcher, Manchester, CT (US)

(21) Appl. No.: 15/032,752

(22) PCT Filed: Dec. 3, 2014
(86) PCT No.: PCT/US14/68318

§ 371 Date: Apr. 28, 2016

Related U.S. Application Data
(60) Provisional application No. 61/915,722, filed on Dec. 13, 2013.

(51) Int. Cl. B22F 3/105; B23P 15/02; B23K 26/342; B23P 15/00; B23H 9/10; B23K 15/00

(52) U.S. Cl. CPC B22F 3/1055; B23H 9/10; B23K 15/0086; B23K 26/342; B23P 15/006; B23P 15/02; B33Y 10/00

(57) ABSTRACT

A method includes forming a component on a layer-by-layer basis using additive manufacturing, forming a shroud support structure on a layer-by-layer basis using additive manufacturing, and removing the shroud support structure after forming the component. The component includes a central portion and at least one feature extending generally radially from a first end connected to the central portion to a second end distal to the central portion. The shroud support structure is connected to the second end of the at least one feature.

### BACKGROUND

Additive manufacturing is an alternative to traditional manufacturing techniques such as casting, forging and machining Additive manufacturing processes can build near-net-shape components with fine features that are not achievable using casting or forging, and do so with limited process waste. Additive manufacturing provides the most value when minimal post-build processing is required.

In additive manufacturing, state of the art support structures are consumable, non-functional solid features that are generated in addition to the target component that (1) provide a continuous layer-by-layer upward progression of powder material used in the additive manufacturing process and/or (2) provide support to horizontal or overhanging features. Support structures are traditionally generated below the work piece's overhanging surfaces.

FIG. 1 illustrates one example of support structures formed below overhanging surfaces. FIG. 1 illustrates integrally bladed rotor 100 having blades 102 supported by support structures 104. Integrally bladed rotor 100 is built using additive manufacturing from the bottom up, progressing in the z direction.

After building, support structures are removed from or machined off the finished work piece. Support structures of the type shown in FIG. 1 are generally difficult to remove, leaving marks on the component surfaces that are not desired for in-service operation. For instance, marks left by support structure 104 on blade 102 are located on the main body of blade 102 and can negatively impact airflow, turbulence, thermal stability and the overall performance of integrally bladed rotor 100. Support structures 104 also do not prevent the terminal ends of blades 102 from warping or curling due to localized heating of blades 102 during the melting phases of additive manufacturing.

### SUMMARY

A method includes forming a component on a layer-by-layer basis using additive manufacturing, forming a shroud support structure on a layer-by-layer basis using additive manufacturing, and removing the shroud support structure after forming the component. The component includes a central portion and at least one feature extending generally radially from a first end connected to the central portion to a second end distal to the central portion. The shroud support structure is connected to the second end of the at least one feature.

### BRIEF DESCRIPTION OF THE DRAWINGS

FIG. 1 is a perspective view of an integrally bladed rotor with a state of the art support structure.

FIG. 2 is a perspective view of an integrally bladed rotor with a shroud support structure.

FIG. 3 is a perspective view of the integrally bladed rotor of FIG. 2 following removal of the shroud support structure.

FIG. 4 is a perspective view of a helical impeller with a shroud support structure.

FIG. 5 is a perspective view of the helical impeller of FIG. 4 following removal of the shroud support structure.

### DETAILED DESCRIPTION

The present invention provides an additive manufacturing method where a shroud support structure is built along with a component to provide both physical support to radially or horizontally extending component features and serve as a heat sink during the additive manufacturing process. By providing physical support to the features, the shroud support structure ensures that the features remain geometrically controlled and their shape is not affected by feature weight during manufacture (e.g., the weight of the feature does not produce bends, etc.). The shroud support structure also provides a thermal transition path away from the melted area of the current (additive manufacturing) layer, where the increase in area of the current layer is too great relative to the area of the previously melted layers. Without the presence of the shroud support structure, the previous layers act as the sole heat sink for the subsequent layers. By also serving as a heat sink, the shroud support structure prevents local warping of the features. Free ends of radially or horizontally extending features can warp or curl as a result of the heat used to melt metal powder during additive manufacturing processes. One end of each of the features is connected to the shroud support structure to prevent such warping and curling.

According to the present invention, a component with one or more features extending from a central portion is formed along with a shroud support structure on a layer-by-layer basis using additive manufacturing. The features extend from the central portion to the shroud support structure. Following additive manufacturing, the shroud support structure is removed, leaving the finished component. The non-limiting embodiments described herein serve as examples to illustrate the present invention.

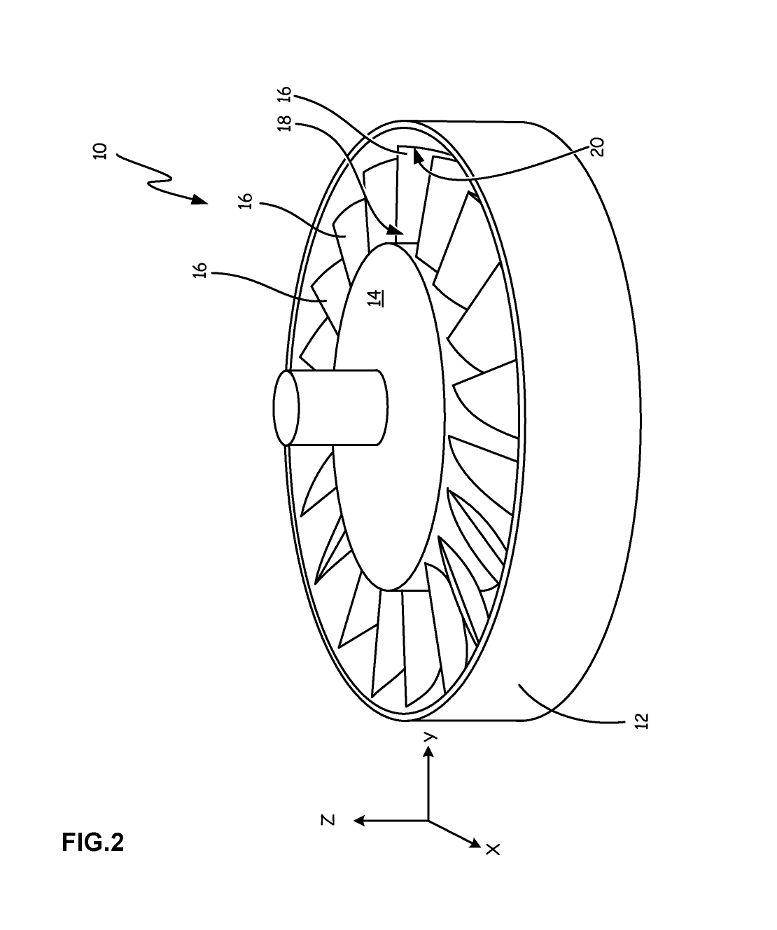

FIG. 2 illustrates one embodiment of a component and shroud support structure built using additive manufacturing. FIG. 2 shows integrally bladed rotor 10 and shroud support structure 12. Integrally bladed rotor 10 includes disk portion 14 and a plurality of blades 16 that extend radially outward from disk portion 14. Each blade 16 includes first end 18 and second end 20. First end 18 of blade 16 is connected to disk portion 14, and second end 20 is connected to shroud support structure 12. As shown in FIG. 2, shroud support structure 12 is a continuous structure in some embodiments (e.g., an annular sheet), connected to the ends of several features (blades 16). Integrally bladed rotor 10, including disk portion 14, blades 16 and shroud support structure 12 are formed using additive manufacturing.

Additive manufacturing is a process of making three-dimensional solid objects using an additive process, where successive layers of material are laid down to form an object having the desired shape. Additive manufacturing techniques include, but are not limited to, direct metal laser sintering (DMLS), selective laser sintering (SLS), selective laser melting (SLM), and electron beam melting (EBM). Generally speaking, in DMLS, SLS and SLM, a metal powder is deposited on a build platform and a high-power laser is used to sinter or melt the metal powder. A part is built up from the build platform layer by layer, alternating deposition and laser sintering/melting steps. A three-dimensional model of the desired part is used to direct the placement of each layer of metal powder prior to laser sintering/melting. This process allows for the automated manufacture of highly complex geometries with a net or near net shape. DMLS is often used for metal alloy powders, SLS is often used for metal and ceramic powders, and SLM is often used for titanium alloys and stainless steel. In EBM, metal powder layers are melted with an electron beam, sometimes under high vacuum, instead of a laser. EBM is often used for titanium alloys.

Disk portion 14, blades 16 and shroud support structure 12 are formed together layer by layer. In one embodiment, the build proceeds in the z direction as shown in FIG. 2 (i.e. towards the top of the page) and disk portion 14, blades 16 and shroud support structure 12 are all manufactured during a single additive manufacturing operation. Disk portion 14, blades 16 and shroud support structure 12 can all be manufactured using the same type of material.

As blades and shroud support structure 12 are additively manufactured, shroud support structure 12 provides both physical support and thermal stability to blades 16. Blades 16 extend radially from disk portion 14 to shroud support structure 12. Without shroud support structure 12, blades 16 would extend from disk portion 14 in a cantilevered fashion. An unsupported cantilevered feature can be prone to geometric flaws during manufacturing. Cantilevered features can bend due to component weight at or near the terminal end. Shroud support structure 12 provides support to blades 16 so that such weight and bending issues are not observed.

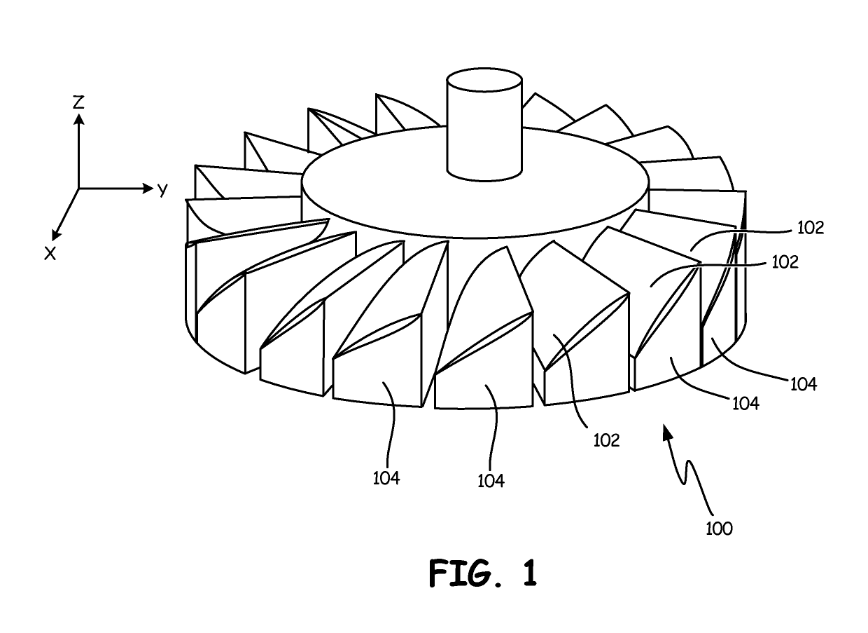

Shroud support structure 12 also provides thermal stability to blades 16 during manufacturing. Blades 16 are exposed to elevated temperatures during manufacturing (i.e. when metal powder layers are sintered/melted). As a result of these elevated temperatures, blades 16 are prone to warping during the manufacturing process. This is especially true at the radially terminal ends (second ends 20) of blades 16. Second end 20 of an unsupported blade 16 can curl towards the heat source (laser, electron beam) during manufacture, resulting in unacceptable feature geometries. Support structures of the type shown in FIG. 1 (support structures 104) do not prevent this type of warping and curling. For example, support structures 104 are located underneath the cantilevered feature (blades 102) and do not effectively remove heat from the blades during processing. Support structures 104 were built earlier in the process and do not contact the metal powder layers that are processed to form blades 102. Thus, while support structures 104 provide some degree of physical support, they do not provide significant heat sink capacity to reduce the localized increase in temperature experienced by blades 102 as they are formed.

Shroud support structure 12, on the other hand, is built at the same time as blades 16. Metal powder used to form shroud support structure 12 is present for each layer of blade 16. Portions of shroud support structure 12 are also present below the layer being heated at a given time. The presence of the earlier formed portions of shroud support structure 12 and the current shroud support structure layer provide heat sink capacity during the formation of blades 16. The heat used to sinter or melt the metal powder layers is able to be spread to shroud support structure 12 instead of just second end 20 of blade 16. The heat sink capacity of shroud support structure 12 and connection to blade 16 prevents warping and curling of blade 16 at second end 20.

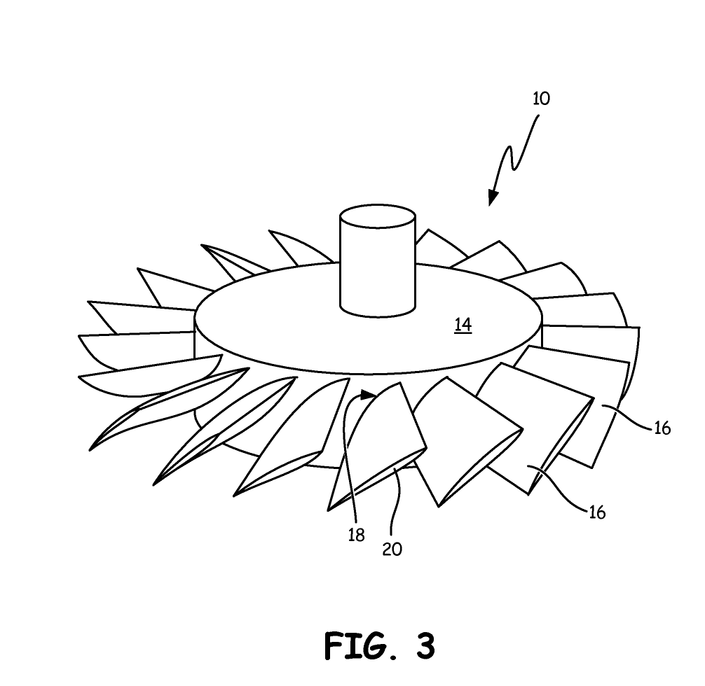

Once integrally bladed rotor 10 and shroud support structure 12 have been formed and allowed to cool and/or solidify, shroud support structure 12 is removed from integrally bladed rotor 10. Once shroud support structure 12 has been removed, integrally bladed rotor is finished, left with only disk portion 14 and blades 16. FIG. 3 illustrates integrally bladed rotor 10 after shroud support structure 12 has been removed. As shown in FIG. 3, blades 16 are cantilevered from disk portion 14.

Shroud support structure 12 can be removed from integrally bladed rotor 10 in different ways. In some embodiments, shroud support structure 12 is removed from integrally bladed rotor 10 in a single step and/or using a single machine setup. In one embodiment, shroud support structure 12 is removed using electrical discharge machining (EDM). Electrodes discharge along second end 20 of blades 16 to sever the connection between blades 16 and shroud support structure 12. For some applications, EDM is precise enough to remove shroud support structure 12 without requiring further finishing or machining of second ends 20 of blades 16.

In embodiments where the shroud support structure is circular, a lathing operation can be used to remove the shroud support structure from the component. For example, integrally bladed rotor 100 with shroud support structure 12 can be mounted to a lathe so that integrally bladed rotor 100 is rotated about the center axis of disk portion 14. As integrally bladed rotor 100 and shroud support structure 12 are rotated, shroud support structure 12 is removed by cutting or abrading. For some applications, the above described lathing operation is precise enough to remove shroud support structure 12 without requiring further finishing or machining of second ends 20 of blades 16.

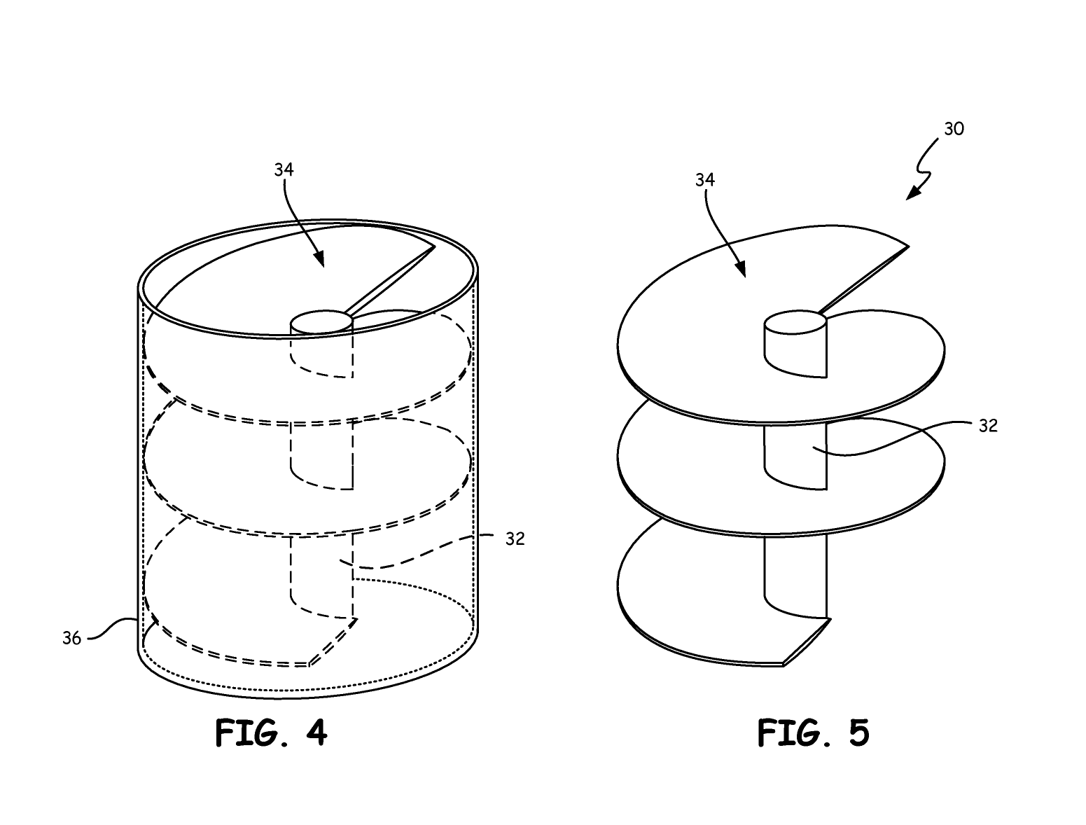

While FIGS. 2 and 3 illustrate integrally bladed rotor 10, other component geometries can benefit from the present invention. In other embodiments, the features extending from a central portion can be airfoils, fins or a continuous bladed structure. FIGS. 4 and 5 illustrate helical impeller 30. Helical impeller 30 includes central portion 32 and blade 34. Blade 34 can be a continuous structure that extends radially from central portion 32 for several “turns”. Shroud support structure 36 is built around helical impeller 30 as described above so that it is connected to blade 34, providing physical and thermal support during additive manufacturing. Shroud support structure 36 is then removed from helical impeller 30 as described above.

The present invention provides reduced production time and costs compared to state of the art support structures. The shroud support structure described herein provides both physical and thermal support to component features, reducing the need for post-additive manufacturing process steps (i.e. further machining to correct defects, warping, etc.) and providing a component that can be immediately ready for service following removal of the shroud support structure.

### Discussion of Possible Embodiments

The following are non-exclusive descriptions of possible embodiments of the present invention.

A method can include forming a component on a layer-by-layer basis using additive manufacturing, forming a shroud support structure on a layer-by-layer basis using additive manufacturing, and removing the shroud support structure after forming the component. The component can include a central portion and at least one feature extending generally radially from a first end connected to the central portion to a second end distal to the central portion. The shroud support structure can be connected to the second end of the at least one feature.

The method of the preceding paragraph can optionally include, additionally and/or alternatively, any one or more of the following features, configurations and/or additional components:

A further embodiment of the foregoing method can include that the at least one feature is cantilevered from the central portion.

A further embodiment of any of the foregoing methods can include that the component comprises a plurality of cantilevered features.

A further embodiment of any of the foregoing methods can include that the cantilevered features are airfoils.

A further embodiment of any of the foregoing methods can include that the cantilevered features are blades.

A further embodiment of any of the foregoing methods can include that the cantilevered features are fins.

A further embodiment of any of the foregoing methods can include that the component is an integrally bladed rotor.

A further embodiment of any of the foregoing methods can include that the at least one feature is a blade.

A further embodiment of any of the foregoing methods can include that the component is a helical impeller.

A further embodiment of any of the foregoing methods can include that removing the shroud support structure is performed using electrical discharge machining.

A further embodiment of any of the foregoing methods can include that removing the shroud support structure is performed using a lathe coupled with cutting or abrading.

A further embodiment of any of the foregoing methods can include that the shroud support structure provides physical support to the at least one feature, and wherein the shroud support structure serves as a heat sink to prevent warping near the second end of the at least one feature.

A further embodiment of any of the foregoing methods can include that the component and the shroud support structure are formed using the same material.

A further embodiment of any of the foregoing methods can include that the shroud support structure is a continuous structure.

Although the present invention has been described with reference to preferred embodiments, workers skilled in the art will recognize that changes may be made in form and detail without departing from the spirit and scope of the invention.

1. A method comprising:
forming a component on a layer-by-layer basis using additive manufacturing, wherein the component comprises:
a central portion; and
at least one feature extending generally radially from a first end connected to the central portion to a second end distal to the central portion;
forming a shroud support structure on a layer-by-layer basis using additive manufacturing, wherein the shroud support structure is connected to the second end of the at least one feature; and
removing the shroud support structure after forming the component.

2. The method of claim 1, wherein the at least one feature is cantilevered from the central portion.

3. The method of claim 2, wherein the component comprises a plurality of cantilevered features.

4. The method of claim 3, wherein the cantilevered features are airfoils.

5. The method of claim 4, wherein the cantilevered features are blades.

6. The method of claim 3, wherein the cantilevered features are fins.

7. The method of claim 5, wherein the component is an integrally bladed rotor.

8. The method of claim 2, wherein the at least one feature is a blade.

9. The method of claim 8, wherein the component is a helical impeller.

10. The method of claim 1, wherein removing the shroud support structure is performed using electrical discharge machining.

11. The method of claim 1, wherein removing the shroud support structure is performed using a lathe coupled with cutting or abrading.

12. The method of claim 1, wherein the shroud support structure provides physical support to the at least one feature, and wherein the shroud support structure serves as a heat sink to prevent warping near the second end of the at least one feature.

13. The method of claim 1, wherein the component and the shroud support structure are formed using the same material.

14. The method of claim 1, wherein the shroud support structure is a continuous structure.
